(19) United States
(12) Patent Application Publication
(10) Pub. No.: US 2015/0064486 A1
(43) Pub. Date: Mar. 5, 2015

(54) ELECTROPHOTOGRAPHIC RECORDING MATERIAL

(71) Applicant: MITSUBISHI PAPER MILLS LIMITED, Tokyo (JP)

(72) Inventors: Takao Arai, Tokyo (JP); Kengo Yamane, Tokyo (JP)

(21) Appl. No.: 14/378,231

(22) PCT Filed: Feb. 5, 2013
(86) PCT No.: PCT/JP2013/052530

§ 371 Date: Aug. 12, 2014

(30) Foreign Application Priority Data
Feb. 28, 2012 (JP) 2012-041952
Dec. 17, 2012 (JP) 2012-274766

(51) Int. Cl. G03G 7/00

(52) U.S. Cl. CPC G03G 7/00
USPC 428/511

(57) ABSTRACT

An electrophotographic recording material that exhibits yellowing resistance, has high toner fixing strength, and prevents double-feeding of the recording material caused by the recording material having become charged with static electricity is provided. The electrophotographic recording material of the present invention includes a support and a toner receiving layer provided on at least one side of the support, the support is thermoplastic resin-coated paper, and the toner receiving layer includes an ionomer resin and a surfactant having an alkyl betaine structure or a fatty acid amidopropyl betaine structure.

### TECHNICAL FIELD

The present invention relates to an electrophotographic recording material.

### BACKGROUND ART

Electrophotographic recording is applied in various fields, including photocopiers as well as printouts from computer terminals, facsimiles and small-volume printing. With the remarkable progress made in the area of output devices, in addition to improvement of printing speed and full-color printing, higher image quality has been achieved and color reproducibility has improved considerably through the use of improved toner, enabling electrophotographic recording to be used in various applications ranging from document output to photograph output.

Among the types of electrophotographic recording methods, dry electrophotographic methods are typically employed in photocopiers and similar applications, and the toner used to form images is a solid powdered toner composed of pigment and binder resin. The method used to form images includes causing toner to be adsorbed to an electrostatic image on a photosensitive roller generated by corona charging, transferring the toner to a recording material, and heating the transferred recording material with a fixing roller to fix the toner and form an image. In these methods, it is difficult to obtain high resolution due to limitations on toner fineness. In addition, since gloss increases at those areas of the image where the toner is fixed, a difference in gloss results between those areas and areas where images are not formed, thereby resulting in the problem of unnatural image rendering.

On the other hand, in the case of wet electrophotographic methods, since toner is dispersed in a liquid, there are no problems attributable to scattering of powder, fineness can be reduced to one-tenth or less that of dry electrophotographic methods, or in other words, extremely fine dots can be formed at those locations where images are formed, there are no problems with respect to weather resistance since pigment can be used for the coloring material, and images are free of differences in gloss, thereby making these methods preferable for photograph output.

The method used to form images in the case of wet electrophotographic methods includes causing toner to be adsorbed onto an electrostatic image on a photosensitive roller in the same manner as dry electrophotographic methods, followed by transferring the toner to a blanket roller using electrical repulsion. The surface of the blanket roller is composed of a material such as silicon rubber having a low level of interfacial free energy, and in these methods, toner is transferred front the blanket roller to a recording material, and the blanket roller is then heated causing the toner to enter a molten state enabling it to be fixed to the recording material and form an image. In these methods, the blanket roller, recording material or wet toner are required to have the ability to enable wet toner to be favorably transferred from the blanket roller to the recording material, and so-called toner transferability is important.

Due to the nature of recording materials, there are cases in which problems occur such as the toner particles causing inadequate image reproduction as a result of not being adequately transferred to the recording material, the strength at which toner is fixed is weak after being transferred from the bracket roller to the recording material, or the toner separates from the recorded surface. Therefore, a commonly known method referred to as “sapphire treatment” is employed as a means for enabling toner to adequately transfer to a recording material to allow the obtaining of a high level of toner fixing strength. In this method, a yellow substance forms in a comparatively short period of time, causing the occurrence of a phenomenon known as white paper yellowing whereby a white background becomes yellow, and resulting in the shortcoming of fluctuations in image color development.

Since a high level of surface smoothness is required in the case of photographic output, the recording material preferably uses a polymer film or thermoplastic resin-coated paper, obtained by coating a paper base material composed mainly of natural pulp with a resin capable of forming a film, as a support. However, since adequate toner fixation is unable to be obtained in the case of thermoplastic resin-coated paper or polymer film, configurations have been proposed that provide a toner receiving layer. For example, an electrophotographic recording material has been proposed that is provided with a specific polypropylene resin layer on both sides of a paper base material and has a toner receiving layer thereon (see, for example, Patent Document 1). In addition, an electrophotographic recording material has been proposed that has a toner receiving layer, containing a resin having a prescribed glass transition point, a resistance reducing agent and organic polymer fine particles, on a polymer film (see, for example, Patent Document 2).

An electrophotographic recording material has also been proposed that includes adding an antistatic agent to a toner receiving layer in order to prevent double-feeding of the recording material caused by the recording material having become charged with static electricity (see, for example, Patent Document 3).

An electrophotographic recording material has been proposed in which an antistatic agent is added to thermoplastic resin-coated paper used as a support in order to prevent double-feeding of the recording material caused by the recording material having become charged with static electricity (see, for example, Patent Document 4).

### PRIOR ART DOCUMENTS

### Patent Documents

Patent Document 1: Japanese Unexamined Patent Publication No. 2002-351121

Patent Document 2: Japanese Unexamined Patent Publication No. 2007-065517

Patent Document 3: Japanese Unexamined Patent Publication No. H11-119460

Patent Document 4: Japanese Unexamined Patent Publication No. 2006-240186

### DISCLOSURE OF THE INVENTION

### Problems to be Solved by the Invention

However, the toner receiving layer as described in Patent Document 1 or Patent Document 2 is still inadequate in terms of toner fixation when using a wet electrophotographic method. In addition, these electrophotographic recording materials are unable to prevent double-feeding of the recording material caused by the recording material having become charged with static electricity.

In the electrophotographic recording material disclosed in Patent Document 3, although double-feeding of the recording material caused by the recording material becoming charged with static electricity can be prevented, the antistatic agent moistens the surface of the toner receiving layer resulting in the occurrence of so-called sticking, while also resulting in problems such as increased susceptibility to the adhesion of fingerprints or scratching.

In the electrophotographic recording material disclosed in Patent Document 4, although double-feeding of the recording material caused by the recording material becoming charged with static electricity can be prevented, since the antistatic agent and thermoplastic resin of the thermoplastic resin-coated paper are not uniformly mixed, this lack of mixing uniformity has an effect on the toner recording surface thereby resulting in the shortcoming of unevenness of images.

Thus, there has yet to be an electrophotographic recording material that demonstrates superior toner fixing strength while inhibiting white paper yellowing of the recording material, while also being able to prevent double-feeding of the recording material caused by the recording material becoming charged with static electricity.

An object of the present invention is to provide an electrophotographic recording material that is resistant to white paper yellowing, demonstrates superior toner fixing strength after printing, and is able to prevent double-feeding of the recording material caused by the recording material becoming charged with static electricity.

### Means for Solving the Problems

The aforementioned object of the present invention is basically achieved by an electrophotographic recording material, including:

a support, and

a toner receiving layer provided on at least one side of the support, wherein

the support is thermoplastic resin-coated paper, and

the toner receiving layer includes an ionomer resin, and a surfactant having an alkyl betaine structure or a fatty acid amidopropyl betaine structure.

According to the electrophotographic recording material of the present invention, white paper yellowing of the recording material can be inhibited, superior toner fixing strength after printing can be demonstrated in an electrophotographic method and particularly a wet electrophotographic method, and double-feeding of the recording material caused by the recording material becoming charged with static electricity can be prevented.

In the electrophotographic recording material of the present invention, the additive ratio of the surfactant having an alkyl betaine structure or fatty acid amidopropyl betaine structure in the aforementioned toner receiving layer is 0.3% by mass to 8% by mass based on the content of the ionomer resin.

As a result of the surfactant additive ratio being within the aforementioned range, the electrophotographic recording material is able to more consistently prevent double-feeding and demonstrate even more superior toner fixing strength.

### BEST MODE FOR CARRYING OUT THE INVENTION

In the case of wet electrophotographic methods, a toner dispersion is used in which toner particles are dispersed in a liquid. Sapphire treatment, which has been used in the prior art for recording materials for use in wet electrophotographic methods, refers to treatment method based on the principle of fixing an anionic toner dispersion by coating a cationic organic component such as ethyleneimine onto the surface of a recording material in order to enhance toner fixing strength. However, sapphire treatment has the problem of causing white paper yellowing or resulting in discoloration of printed images following printing due to the cationic organic component used reacting with other substances present due to the high reactivity thereof.

In the present invention, the toner receiving layer at least includes an ionomer resin. As a result, in addition to obtaining high toner fixing strength, problems such as white paper yellowing like that occurring in the ease of the aforementioned sapphire treatment were found to not occur. The reason for being able to obtain high toner fixing strength is thought to be because of the toner dispersion being fixed by metal ions present in the ionomer resin. The reason for the absence of problem such as white paper yellowing is thought to be due to the low level of reactivity of the ionomer resin used.

In the present invention, the toner receiving layer at least includes a surfactant having an alkyl betaine structure or fatty acid amidopropyl betaine structure in addition to the ionomer resin. As a result of containing a surfactant having an alkyl betaine structure or fatty acid amidopropyl betaine structure, the electrophotographic recording material is prevented from becoming charged and double-feeding of the recording material caused by the recording material becoming charged with static electricity can be prevented.

Moreover, in the present invention, as a result of the toner receiving layer containing a combination of an ionomer resin and a surfactant having an alkyl betaine structure or fatty acid amidopropyl betaine structure, the ionomer resin and the surfactant having an alkyl betaine structure or fatty acid amidopropyl betaine structure strongly interact, resulting in a structure in which they are mutually constrained. As a result, the problem of the occurrence of stickiness, as well as increased susceptibility to adhesion of fingerprints or scratching as a result of the surfactant moistening the surface of the toner receiving layer, do not occur.

In the present invention, a conventionally known ionomer resin can be used for the ionomer resin used in the toner receiving layer, and is preferably an ethylene-based ionomer resin. Ethylene-based ionomer resins are ionic polymers obtained by adding a metal ion having a valence of 1 to 3 to a copolymer of an α-olefin containing ethylene and an α,β-unsaturated carboxylic acid, and have an intermolecular structure crosslinked by metal ions as shown below.

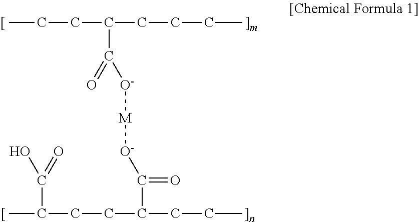

In the above formula, M represents a metal on having a valence of 1 to 3, and m and n represent arbitrary integers.

Here, typical examples of α,β-unsaturated carboxylic acids include acrylic acid, methacrylic acid and itaconic acid. In addition, typical examples of metal ions having a valence of 1 to 3 include Na⁺, K⁺, Ca²⁺, Zn²⁺ and Al³⁺. Examples of ethylene-based ionomer resins include ionomer resins of ethylene-unsaturated carboxylic acid copolymers, and crosslinked products of ionomers of ethylene-unsaturated carboxylic acid copolymers and polyvalent epoxy compounds. An ionomer resin of an ethylene-unsaturated carboxylic acid copolymer is preferable in terms of preventing double-feeding. Ionomer resins are commercially available and can be acquired from, for example, Sumitomo Seika Chemicals Co., Ltd.

In the present invention, the surfactant used in the toner receiving layer has an alkyl betaine structure or fatty acid amidopropyl betaine structure.

A surfactant having an alkyl betaine structure is represented by, for example, the following general formula:

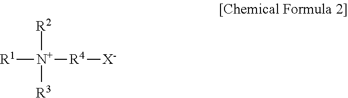

(wherein, R¹, R² and R³ may be the same or different and represent optionally substituted alkyl groups, R⁴ represents an optionally substituted alkylene group, and X⁻ represents a monovalent anionic residue).

One of R¹, R² and R³ more preferably represents an alkyl group having 6 or more carbon atoms while the other two more preferably represent alkyl groups having 1 to 2 carbon atoms, and each may have a substituent.

R⁴ more preferably represents an alkylene group having 2 to 4 carbon atoms and may also have a substituent.

X⁻ more preferably represents COO⁻ or SO₃⁻.

Examples of each substituent include alkyl groups, halogen atoms, hydroxyl groups, amino groups and cyano groups.

In the present invention, however, the surfactant having an alkyl betaine structure does not include amphoteric surfactants having an imidazolinium betaine structure. Examples of amphoteric surfactants having an imidazolinium betaine structure include 2-alkyl-N-carboxymethyl-N-hydroxyethyl imidazolinium betaine and 2-alkyl-N-carboxymethyl-N-aminoethyl imidazolinium betaine.

A surfactant having a fatty acid amidopropyl betaine structure is represented by, for example, the following general formula:

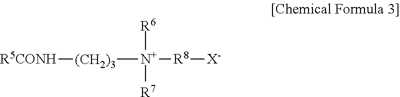

(wherein, R⁵, R⁶ and R⁷ may be the same or different and represent optionally substituted alkyl groups, R⁸ represents an optionally substituted alkylene group, and X⁻ represents a monovalent anionic residue).

R⁵, R⁶ and R⁷ are more preferably such that R⁵ represents an alkyl group having 5 or more carbon atoms, R⁶ and R⁷ respectively and independently represent an alkyl group having 1 to 2 carbon atoms, and R⁵, R⁶ and R⁷ may each have a substituent.

R⁸ more preferably represents an alkylene group having 2 to 4 carbon atoms and may also have a substituent.

X⁻ more preferably represents COO⁻ or SO₃⁻.

Examples of each substituent include alkyl groups, halogen atoms, hydroxyl groups, amino groups and cyano groups.

Specific examples of surfactants having an alkyl betaine structure include hexyl dimethyl aminoacetic acid betaine, hexyl dimethyl aminopropionic acid betaine, octyl dimethyl aminoacetic acid betaine, octyl dimethyl aminopropionic acid betaine, octyl dihydroxyethyl aminoacetic acid betaine, decyl dimethyl aminoacetic acid betaine, decyl dimethyl aminopropionic acid betaine, decyl dihydroxyethyl aminoacetic acid betaine, undecyl dimethyl aminoacetic acid betaine, undecyl dimethyl aminopropionic acid betaine, lauryl dimethyl aminoacetic acid betaine, lauryl dimethyl aminopropionic acid betaine, lauryl dihydroxyethyl aminoacetic acid betaine, lauryl dihydroxyethyl aminopropionic acid betaine, myristyl dimethyl aminoacetic acid betaine, myristyl dimethyl aminopropionic acid betaine, myristyl dihydroxyethyl aminoacetic acid betaine, myristyl dihydroxyethyl aminopropionic acid betaine, palmityl dimethyl aminoacetic acid betaine, palmityl dimethyl aminopropionic acid betaine, palmityl dihydroxyethyl aminoacetic acid betaine, palmityl dihydroxyethyl aminopropionic acid betaine, stearyl dimethyl aminoacetic acid betaine, stearyl dimethyl aminopropionic acid betaine, stearyl dihydroxyethyl aminoacetic acid betaine, stearyl dihydroxyethyl aminopropionic acid betaine, behenyl dimethyl aminoacetic acid betaine, behenyl dimethyl aminopropionic acid betaine, lauryl dimethyl aminosulfopropyl betaine (C₁₂H₂₅(CH₃)₂N⁺(CH₂)₃SO₃⁻) and stearyl dimethyl aminosulfopropyl betaine (C₁₈H₃₇(CH₃)₂N⁺(CH₂)₃SO₃⁻).

These are commercially available and can be acquired from, for example, Kao Corp. or Nikko Chemicals Co., Ltd.

Specific examples of surfactants having a fatty acid amidopropyl betaine structure include cocamidobetaine (main component: C₁₁H₂₃CONH(CH₂)₃N⁺(CH₃)₂CH₂COO—; lauryl amidopropyl dimethyl aminoacetic acid betaine) and cocamidopropyl hydroxysultaine (main component: C₁₁H₂₃CONH(CH₂)₃N⁺(CH₃)₂CH₂CHOHCH₂SO₃⁻; 3-(N-laurylamidopropyl-N,N-dimethylamino)-2-hydroxypropyl sultaine).

These are commercially available and can be acquired from, for example, Kao Corp. or Nikko Chemicals Co., Ltd.

In the present invention, the additive ratio of the surfactant having an alkyl betaine structure or fatty acid amidopropyl betaine structure in the toner receiving layer is preferably 0.3% by mass to 8% by mass based on the content of the ionomer resin from the viewpoints of consistently preventing double-feeding and toner fixing strength. If the additive ratio of the surfactant is 0.3% by mass or more, adequate prevention of charging of the electrophotographic recording material can be achieved, and double-feeding of the electrophotographic recording material can be completely prevented. If the additive ratio of the surfactant is 8% by mass or less, adequate toner fixing strength is obtained.

In the present invention, the toner receiving layer may also contain an inorganic pigment component. Examples of inorganic pigment components include silica, alumina and alumina hydrate, titanium oxide, zinc oxide and barium sulfate.

In the present invention, the toner receiving layer may also contain a binder. A known binder can be used for the binder, and examples thereof include styrene-butadiene copolymers, polymers or copolymers containing acrylic acid, methacrylic acid or an ester or other derivative thereof, vinyl acetate-based polymers such as vinyl acetate polymers, vinyl acetate-maleic acid ester copolymers, ethylene-vinyl acetate copolymers or vinyl acetate-vinyl chloride copolymers, polyvinyl ether, alkyl vinyl ether-maleic anhydride copolymers, styrene-maleic anhydride copolymers and salts thereof, vinylidene chloride-based copolymers and functional group-modified polymers consisting of functional group-containing monomers thereof such as the carboxyl groups of the above mentioned various types of polymers, synthetic polymers such as polyvinylpyrrolidone, polyvinyl pyridinium halides, polyethylene glycol or polypropylene glycol, adhesives such as melamine resin, urea resin and other thermosetting synthetic resins and synthetic resin-based adhesives such as polyurethane resin, polyvinyl butyral or alkyd resin, gelatin, starches such as oxidized starch, cationized starch or etherified starch and cellulose derivatives such as carboxymethyl cellulose or hydroxyethyl cellulose. These binders can be used alone or in combination.

Various types of inorganic acids, organic acids, pH adjusters, image preservatives, colorants, thickeners and other surfactants and the like can be suitably added to the toner receiving layer.

The thickness of the toner receiving layer in the present invention is preferably 0.05 μm to 10 μm.

The support in the present invention is thermoplastic resin-coated paper. Thermoplastic resin-coated paper refers to that in which both sides of a paper base material having natural pulp as the main component thereof are coated with a thermoplastic resin capable of forming a film. Examples of resins that can be preferably used for the coating thermoplastic resin include hydrocarbon-based plastics, polar vinyl-based plastics, linear structure plastics and cellulose-based plastics. Examples of hydrocarbon-based plastics include polyethylene, polypropylene, polymethylpentene, polybutene crystalline polybutadiene, polystyrene, polybutadiene and styrene-butadiene copolymers. Examples of polar vinyl-based plastics include polyvinyl chloride, polyvinyl acetate, polyvinylidene chloride, ethylene-vinyl acetate copolymer, ionomers and polymethyl methacrylate. Examples of linear structure plastics include polyacetals, polyamides, polycarbonates, polyphenylene ether, polyethylene terephthalate, polybutylene terephthalate, polyether sulfones, polyimides, polyamidoimides, polyphenylene sulfide, polyoxybenzoyl, polyether ether ketone and polyetherimide. Examples of cellulose-based plastics include cellulose acetate, cellulose acetate butyrate, cellophane and celluloid. The thickness of the resin coating layer is preferably 5 μm to 60 μm per side. The thickness of the support is preferably 50 μm to 300 μm.

The electrophotographic recording material of the present invention can be produced by coating a coating solution of the toner receiving layer onto the support followed by drying to form a toner receiving layer. A direct gravure coater, offset gravure coater, micro gravure coater, reverse gravure coater, reverse roll coater, extrusion bar coater, curtain coater, air knife coater, bar coater, comma coater, die coater, lip coater, wire bar coater, blade coater, slide hopper coater and combinations thereof can be used to coat the coating solution of the toner receiving layer onto the support. Various types of drying devices can be used to dry the coated coating solution, such as hot air dryers, examples of which include a linear drying tunnel, arch dryer, air loop dryer and sine curve air float dryer, infrared rays, heating dryers or microwave dryers.

Although the electrophotographic recording material of the present invention can be used in both dry electrophotographic methods and wet electrophotographic methods, it is particularly suited for recording by a wet electrophotographic method.

### EXAMPLES

The following provides a more detailed explanation of the present invention through examples thereof. Furthermore, the present invention is naturally not limited to the examples. In the following explanation, the term “%” refers to percent by mass as solid fraction unless specifically indicated otherwise. The term “parts” refers to parts by mass as solid fraction unless specifically indicated otherwise.

### Example 1

A surfactant having an alkyl betaine structure in the form of butyl dimethyl aminoacetic acid betaine (Nikkol AM-301, Nikko Chemicals Co., Ltd.) was added to an aqueous ionomer resin dispersion of an ethylene-unsaturated carboxylic acid copolymer (Zaikthene A, Sumitomo Seika Chemicals Co., Ltd.) at 1.5 parts to 100 parts of ionomer resin followed by the addition of water and adjusting the concentration to 17% to obtain a toner receiving layer coating solution.

The toner receiving layer coating solution was coated onto a support in the form of thermoplastic resin-coated paper having a basis weight of 170 g/m², obtained by melt-laminating polypropylene resin onto both sides of woodfree paper, to a toner receiving layer thickness of 1 μm using a micro gravure coater followed by drying to obtain the electrophotographic recording material of Example 1.

### Example 2

The electrophotographic recording material of Example 2 was obtained using the same method as Example 1 with the exception of changing the surfactant having an alkyl betaine structure in the form of lauryl dimethyl aminoacetic acid betaine (Nikkol AM-301, Nikko Chemicals Co., Ltd.) used in Example 1 lo a surfactant having a fatty acid amidopropyl betaine structure in the form of cocamidopropyl betaine (Amphitol 55AB, Kao Corp.).

### Example 3

The electrophotographic recording material of Example 3 was obtained using the same method as Example 1 with the exception of changing the added amount of the surfactant in the form of lauryl dimethyl aminoacetic acid betaine (Nikkol AM-301, Nikko Chemicals Co., Ltd.) used in Example 1 to 0.33 parts.

### Example 4

The electrophotographic recording material of Example 4 was obtained using the same method as Example 2 with the exception of changing the added amount of surfactant in the form of cocamidopropyl betaine (Amphitol 55AB, Kao Corp.) used in Example 2 to 0.33 parts.

### Example 5

The electrophotographic recording material of Example 5 was obtained using the same method as Example 1 with the exception of changing the added amount of the surfactant in the form of lauryl dimethyl aminoacetic acid betaine (Nikkol AM-301, Nikko Chemicals Co., Ltd.) used in Example 1 to 7.6 parts.

### Example 6

The electrophotographic recording material of Example 6 was obtained using the same method as Example 2 with the exception of changing the added amount of surfactant in the form of cocamidopropyl betaine (Amphitol 55AB, Kao Corp.) used in Example 2 to 7.6 parts.

### Example 7

The electrophotographic recording material of Example 7 was obtained using the same method as Example 1 with the exception of changing the added amount of the surfactant in the form of lauryl dimethyl aminoacetic acid betaine (Nikkol AM-301, Nikko Chemicals Co., Ltd.) used in Example 1 to 0.27 parts.

### Example 8

The electrophotographic recording material of Example 8 was obtained using the same method as Example 2 with the exception of changing the added amount of surfactant in the form of cocamidopropyl betaine (Amphitol 55AB, Kao Corp.) used in Example 2 to 0.27 parts.

### Example 9

The electrophotographic recording material of Example 9 was obtained using the same method as Example 1 with the exception of changing the added amount of the surfactant in the form of lauryl dimethyl aminoacetic acid betaine (Nikkol AM-301, Nikko Chemicals Co., Ltd.) used in Example 1 to 8.3 parts.

### Example 10

The electrophotographic recording material of Example 10 was obtained using the same method as Example 2 with the exception of changing the added amount of surfactant in the form of cocamidopropyl betaine (Amphitol 55AB, Kao Corp.) used in Example 2 to 8.3 parts.

### Comparative Example 1

The electrophotographic recording material of Comparative Example 1 was obtained using the same method as Example 1 with the exception of not adding the surfactant in the form of lauryl dimethyl aminoacetic acid betaine (Nikkol AM-301, Nikko Chemicals Co., Ltd.) to the toner receiving layer coating solution used in Example 1.

### Comparative Example 2

The electrophotographic recording material of Comparative Example 2 was obtained using the same method as Example 1 with the exception of changing the aqueous ionomer resin dispersion of the toner receiving layer coating solution (Zaikthene A, Sumitomo Seika Chemicals Co., Ltd.) used in Example 1 to an aqueous acrylic resin dispersion (Vinyblan 2772, Nisshin Chemical Industry Co., Ltd.).

### Comparative Example 3

The electrophotographic recording material of Comparative Example 3 was obtained using the same method as Example 1 with the exception of changing the aqueous ionomer resin dispersion of the toner receiving layer coating solution (Zaikthene A, Sumitomo Seika Chemicals Co., Ltd.) used in Example 1 to an aqueous polyester-based resin dispersion (Vylonal MD-1480, Toyobo Co., Ltd.).

### Comparative Example 4

A surfactant having an alkyl betaine structure in the form of lauryl dimethyl aminoacetic acid betaine (Nikkol AM-301, Nikko Chemicals Co., Ltd.) was added to partially saponified polyvinyl alcohol adjusted to a concentration of 10% (PVA217, Kuraray Co., Ltd.) at 1.5 parts to 100 parts of the partially saponified polyvinyl alcohol followed by the addition of water and adjusting the concentration to 7% to obtain a toner receiving layer coating solution.

The toner receiving layer coating solution was coated onto a support in the form of thermoplastic resin-coated paper having a basis weight of 170 g/m², obtained by melt-laminating polypropylene resin onto both sides of woodfree paper, to a toner receiving layer thickness of 1 μm using a micro gravure coater followed by drying to obtain the electrophotographic recording material of Comparative Example 4.

### Comparative Example 5

The electrophotographic recording material of Comparative Example 5 was obtained using the same method as Comparative Example 2 with the exception of not adding the surfactant in the form of lauryl dimethyl aminoacetic acid betaine (Nikkol AM-301, Nikko Chemicals Co., Ltd.) to the toner receiving layer coating solution used in Comparative Example 2.

### Comparative Example 6

The electrophotographic recording material of Comparative Example 6 was obtained using the same method as Comparative Example 3 with the exception of not adding the surfactant in the form of lauryl dimethyl aminoacetic acid betaine (Nikkol AM-301, Nikko Chemicals Co., Ltd.) to the toner receiving layer coating solution used in Comparative Example 3.

### Comparative Example 7

The electrophotographic recording material of Comparative Example 7 was obtained using the same method as Comparative Example 4 with the exception of not adding the surfactant in the form of dimethyl aminoacetic acid betaine (Nikkol AM-301, Nikko Chemicals Co., Ltd.) to the toner receiving layer coating solution used in Comparative Example 4.

### Comparative Example 8

The electrophotographic recording material of Comparative Example 8 was obtained using the same method as Example 1 with the exception of changing the surfactant having an alkyl betaine structure in the form of lauryl dimethyl aminoacetic acid betaine (Nikkol AM-301, Nikko Chemicals Co., Ltd.) used in Example 1 to a cationic surfactant in the form of monostearyl ammonium chloride (Arquad T-28, Lion Corp.).

### Comparative Example 9

The electrophotographic recording material of Comparative Example 9 was obtained using the same method as Example 1 with the exception of changing the surfactant having an alkyl betaine structure in the form of lauryl dimethyl aminoacetic acid betaine (Nikkol AM-301, Nikko Chemicals Co., Ltd.) used in Example 1 to an anionic surfactant in the form of sodium dodecylbenzenesulfonate (Neoplex G-25, Kao Corp.).

### Comparative Example 10

The electrophotographic recording material of Comparative Example 10 was obtained using the same method as Example 1 with the exception of changing the surfactant having an alkyl betaine structure in the form of lauryl dimethyl aminoacetic acid betaine (Nikkol AM-301, Nikko Chemicals Co., Ltd.) used in Example 1 to a nonionic surfactant in the form of polyoxyethylene lauryl ether (Emulgen 104P, Kao Corp.).

### Comparative Example 11

The electrophotographic recording material of Comparative Example 11 was obtained using the same method as Example 1 with the exception of changing the surfactant having an alkyl betaine structure in the form of lauryldimethyl aminoacetic acid betaine (Nikkol AM-301, Nikko Chemicals Co., Ltd.) used in Example 1 to an amphoteric surfactant having imidazolinium betaine structure in the form of 2-alkyl-N-carboxymethyl-N-hydroxyethylimidazolinium betaine (Amphorex 50-SF, Miyoshi Oil & Fat Co., Ltd.).

### Comparative Example 12

A sapphire coating solution having polyethyleneimine as the main component thereof was coated onto the thermoplastic resin-coated paper having a basis weight of 170 g/m², obtained in Example 1 by melt-laminating polypropylene resin onto both sides of woodfree paper, to a sapphire coating layer thickness of 0.6 μm using a micro gravure coater followed by drying to obtain the electrophotographic recording material of Comparative Example 12.

### Comparative Example 13

A sapphire coating solution having polyethyleneimine as a main component thereof was coated onto the electrophotographic recording material obtained in Comparative Example 4 to a sapphire coating layer thickness of 0.6 μm using a micro gravure coater followed by drying to obtain the electrophotographic recording material of Comparative Example 13.

(Evaluation of Toner Fixing Strength)

Printing was carried out on the electrophotographic recording materials using the four standard colors in the 8-bit mode and at 1219 dpi using the HP Indigo 7000 Digital Press printer for the wet electrophotographic printer. Cellophane tape was affixed to black, cyan, magenta and yellow solid printed areas of the electrophotographic recording materials printed at a color density of 100% (color optical density), the tape was then peeled off, and the amount of toner adhered to the tape was observed to evaluate toner fixing strength. Toner adhesive strength was evaluated based on the four evaluation criteria indicated below. In the case of an evaluation of 3 or 4, the electrophotographic recording material was judged to satisfy the standards of the electrophotographic recording material of the present invention.

4: No toner adhered to tape indicating superior toner fixing strength

3: Only a slight amount of toner adhered to tape, indicating favorable toner fixing strength

2: Toner Observed to be adhered to tape, indicating toner fixing strength at the limit of practical use

1: Large amount of toner adhered to tape, indicating a level of fixing strength that prevents practical use

(Evaluation of Double-Feeding Caused by Static Electricity)

Solid gray images were continuously printed on 3000 sheets of the electrophotographic recording materials cut to A3 size at an overall density of 50% (color optical density) using the four standard colors in the 8-bit mode and at 1219 dpi using the HP Indigo 7000 Digital Press printer for the wet electrophotographic printer, and the number of double-feeding of electrophotographic recording materials was counted. Double-feeding was evaluated based on the four evaluation criteria indicated below. In the case of an evaluation of 3 or 4, the electrophotographic recording material was judged to satisfy the standards of the electrophotographic recording material of the present invention.

4: No occurrence of double-feeding

3: Up to two occurrences of double-feeding, absence of double-feeding of 3 or more sheets, no interruption of printing as a result of double-feeding, and double-feeding judged to be of a level that does not present a problem during continuous printing

2: Up to 5 occurrences of double-feeding, interruption of printing as a result of double-feeding, and double-feeding at the lower limit of the level of actual printing work during continuous printing

1: Six or more occurrences of double-feeding, interruption of printing as a result of double-feeding, and double-feeding at an unacceptable level for actual printing work during continuous printing

(Evaluation of Yellowing Resistance)

The amount of change in b* value before and after irradiating the white paper surface of the toner receiving layer of the electrophotographic recording materials with xenon light at 70,000 lux for 120 hours using a xenon fade meter in an environment at 23° C. and 65% RH was defined as Δb, and that value was evaluated based on the four criteria indicated below. In the case of an evaluation of 3 or 4, the electrophotographic recording material was judged to satisfy the standards of the electrophotographic recording material of the present invention.

4: Δb value of less than 0.50, indicating superior yellowing resistance

3: Δb value of 0.50 to less than 1.00, indicating a level of yellowing resistance that does not cause a problem in terms of practical use

2: Δb value of 1.00 to less than 2.00, indicating inferior yellowing resistance that has an effect on color reproduction following printing

1: Δb value of 2.00 or higher, indicating inferior yellowing resistance that is not suitable for practical use

The evaluation results of each of the examples and comparative examples are shown in Table 1.

TABLE 1

| | | Double-feeding | |
|---|---|---|---|
| | Toner fixing | caused by static | Yellowing |
| | strength | electricity | resistance |
| Example 1 | 4 | 4 | 4 |
| Example 2 | 4 | 4 | 4 |
| Example 3 | 4 | 4 | 4 |
| Example 4 | 4 | 4 | 4 |
| Example 5 | 4 | 4 | 4 |
| Example 6 | 4 | 4 | 4 |
| Example 7 | 4 | 3 | 4 |
| Example 8 | 4 | 3 | 4 |
| Example 9 | 3 | 4 | 4 |
| Example 10 | 3 | 4 | 4 |
| Comparative example 1 | 4 | 1 | 4 |
| Comparative example 2 | 2 | 4 | 3 |
| Comparative example 3 | 2 | 4 | 3 |
| Comparative example 4 | 1 | 4 | 4 |
| Comparative example 5 | 2 | 2 | 3 |
| Comparative example 6 | 2 | 1 | 3 |
| Comparative example 7 | 1 | 1 | 4 |
| Comparative example 8 | 1 | 3 | 4 |
| Comparative example 9 | 1 | 3 | 4 |
| Comparative example 10 | 1 | 3 | 4 |
| Comparative example 11 | 1 | 3 | 4 |
| Comparative example 12 | 4 | 2 | 1 |
| Comparative example 13 | 4 | 4 | 1 |

As shown in the results for Examples 1 to 10, an electrophotographic recording material produced under the conditions of the present invention has yellowing resistance, superior toner fixing strength, and is free of or only demonstrates a low frequency of double-feeding that does not present a problem, thereby allowing the achieving of high quality. In Examples 1 to 6, in which the additive ratio of the surfactant having an alkyl betaine structure or fatty acid amidopropyl betaine structure in the toner receiving layer is 0.3% by mass to 8% by mass based on the content of ionomer resin, toner fixability was particularly superior, there was no occurrence of double-feeding and particularly high quality was achieved. As shown in the results for Comparative Examples 1 and 5 to 7, if a surfactant having an alkyl betaine structure or fatty acid amidopropyl betaine structure is not contained, the frequency of the occurrence of double-feeding becomes high making these electrophotographic recording materials unsuitable for practical use. As shown in the results for Comparative Examples 2 to 7, toner fixability was determined to be inadequate unless an ionomer resin is contained. As shown in the results for Comparative Examples 8 and 9, in the case of adding an anionic surfactant or cationic surfactant having a quaternary salt as surfactant, although there are no problems with the occurrence of double-feeding, toner fixability is inadequate. As shown in the results for Comparative Example 10, in the case of adding a surfactant having a nonionic structure and not an amphoteric structure as surfactant, toner fixability is inadequate. As shown in the results for Comparative Example 11, in the case of adding an amphoteric surfactant having an imidazolinium betaine structure, toner fixability is inadequate. With respect to yellowing resistance, as shown in the results for Comparative Example 12, in the case of carrying out sapphire coating treatment without providing the toner receiving layer of the present invention, the frequency of occurrence of double-feeding becomes high and yellowing resistance was determined to be inferior. As shown in the results for Comparative Example 13, in the case of carrying out sapphire coating treatment on the electrophotographic recording material obtained in Comparative Example 4 that demonstrated inadequate toner fixability, although toner fixability improved, yellowing resistance was determined to be inferior.

1. An electrophotographic recording material comprising:
a support, and
a toner receiving layer provided on at least one side of the support, wherein
the support is thermoplastic resin-coated paper, and
the toner receiving layer at least includes an ionomer resin and a surfactant having an alkyl betaine structure or a fatty acid amidopropyl betaine structure.

2. The electrophotographic recording material according to claim 1, wherein the additive ratio of the surfactant having an alkyl betaine structure or fatty acid amidopropyl betaine structure in the toner receiving layer is 0.3% by mass to 8% by mass based on the content of the ionomer resin.
